(19) United States
(12) Patent Application Publication
(10) Pub. No.: US 2026/0204095 A1
(43) Pub. Date: Jul. 16, 2026

(54) AUTHENTICATION SYSTEM, AUTHENTICATION METHOD, AND RECORDING MEDIUM

(71) Applicant: NEC Corporation, Tokyo (JP)

(72) Inventor: Yusuke MORISHITA, Tokyo (JP)

(73) Assignee: NEC Corporation, Tokyo (JP)

(21) Appl. No.: 19/132,009

(22) PCT Filed: Nov. 25, 2022
(86) PCT No.: PCT/JP2022/043605

§ 371 Date: May 22, 2025

(51) Int. Cl. G06V 40/16; G06V 20/52; G06V 40/20; G08B 13/196

(52) U.S. Cl. CPC G06V 40/172; G06V 20/52; G06V 40/20; G08B 13/19613

(57) ABSTRACT

An authentication system includes: an image acquisition unit that acquires an image including a face authentication area through which an authentication subject heading toward an entry restricted area passes; a face authentication unit that performs face authentication on the authentication subject, based on the acquired image; and a display unit that is disposed at least one of above a head and at feet of the authentication subject, and that displays a result of the face authentication after the authentication subject exits from the face authentication area on the entry restricted area side.

### TECHNICAL FIELD

The present disclosure relates to technical fields of an authentication system, an authentication method, and a recording medium.

### BACKGROUND ART

There is proposed, as this type of system, a system that, when a user carrying a portable terminal apparatus enters a ticket gate area, determines whether or not a face image of the user captured at the ticket gate area matches a face image corresponding to identification information on the user, and that performs entry or exit processing when it is determined that there is a match (see Patent Literature 1).

### CITATION LIST

### Patent Literature

Patent Literature 1: JP2013-191172A

### SUMMARY

### Technical Problem

It is an example object of the present disclosure to provide an authentication system, an authentication method, and a recording medium that aim to improve the techniques/technologies disclosed in Citation List.

### Solution to Problem

An authentication system according to an example aspect includes: an image acquisition unit that acquires an image including a face authentication area through which an authentication subject heading toward an entry restricted area passes; a face authentication unit that performs face authentication on the authentication subject, based on the acquired image; and a display unit that is disposed at least one of above a head and at feet of the authentication subject, and that displays a result of the face authentication after the authentication subject exits from the face authentication area on the entry restricted area side.

An authentication method according to an example aspect includes: acquiring an image including a face authentication area through which an authentication subject heading toward an entry restricted area passes; performing face authentication on the authentication subject, based on the acquired image; and displaying a result of the face authentication at least one of above a head and at feet of the authentication subject, after the authentication subject exits from the face authentication area on the entry restricted area side.

A recording medium according to an example aspect of the present disclosure is a recording medium on which a computer program that allows a computer to execute an authentication method is recorded, the authentication method including: acquiring an image including a face authentication area through which an authentication subject heading toward an entry restricted area passes; performing face authentication on the authentication subject, based on the acquired image; and displaying a result of the face authentication at least one of above a head and at feet of the authentication subject, after the authentication subject exits from the face authentication area on the entry restricted area side.

### BRIEF DESCRIPTION OF DRAWINGS

FIG. 1 is a diagram illustrating an example of an authentication system

FIG. 2 is a diagram illustrating an example of a gate to which the authentication system is applied.

FIG. 3 is a diagram illustrating an example of a configuration of a face authentication apparatus.

FIG. 4 is a diagram for describing processing of tracking a person.

FIG. 5 is a diagram illustrating an example of an ID correspondence table.

FIG. 6 is a flowchart illustrating a tracking and face authentication operation according to a second example embodiment.

FIG. 7 is a flowchart illustrating a display control operation according to the second example embodiment.

FIG. 8 is a diagram illustrating an example of a screen displayed on a display apparatus.

FIG. 9 is a diagram illustrating another example of the gate to which the authentication system is applied.

FIG. 10 is a diagram illustrating another example of the gate to which the authentication system is applied.

FIG. 11 is a diagram illustrating another example of the gate to which the authentication system is applied.

### DESCRIPTION OF EXAMPLE EMBODIMENTS

An authentication system, an authentication method, and a recording medium according to example embodiments will be described.

### First Example Embodiment

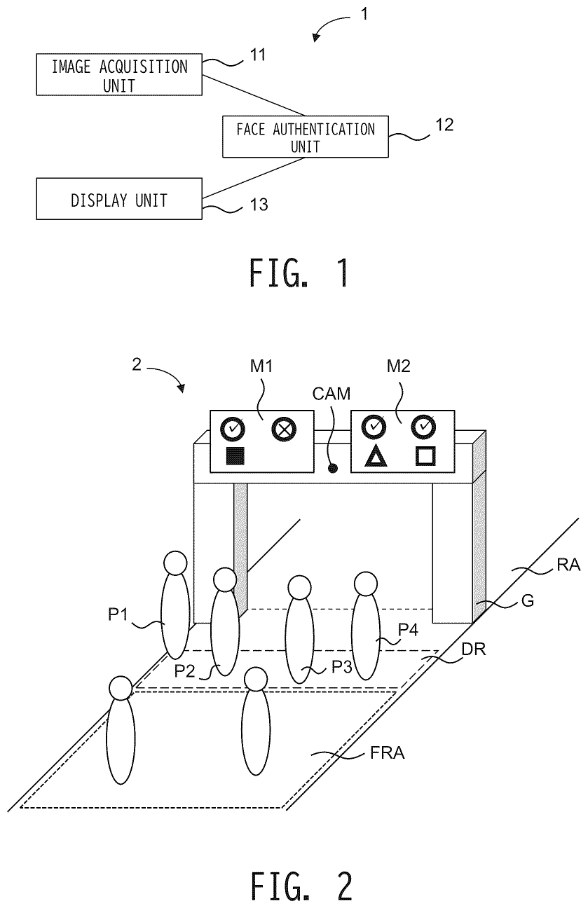

An authentication system, an authentication method, and a recording medium according to a first example embodiment will be described with reference to FIG. 1. The following describes the authentication system, the authentication method, and the recording medium in the first example embodiment, by using an authentication system 1.

The authentication system 1 includes an image acquisition unit 11, a face authentication unit 12, and a display unit 13. The image acquisition unit 11 acquires an image including a face authentication area through which an authentication subject passes toward an entry restricted area. The face authentication unit 12 performs face authentication on the authentication subject, based on the image acquired by the image acquisition unit 11. The display unit 13 is disposed at least one of above a head and at feet of the authentication subject. The display unit 13 displays a result of the face authentication by the face authentication unit 12, after the authentication subject exits from the face authentication area on the entry restricted area side.

It can be said that performed in the authentication system 1 is an authentication method in which the image acquisition unit 11 acquires an image including a face authentication area, in which the face authentication unit 12 performs face authentication based on the acquired image, and in which the display unit 13 displays a result of the face authentication at least one of above the head and at the feet of the authentication subject, after the authentication subject exits from the face authentication area on the entry restricted area side. Such an authentication system 1 may be realized by a computer reading a computer program recorded on a recording medium. In this case, it can be said that a computer program that allows a computer to execute an authentication method is recorded on a recording medium, the authentication method including: acquiring an image including a face authentication area through which an authentication subject heading toward an entry restricted area passes; performing face authentication on the authentication subject, based on the acquired image; and displaying a result of the face authentication at least one of above a head and at feet of the authentication subject, after the authentication subject exits from the face authentication area on the entry restricted area side.

### Technical Effect

The entry restricted area is an area in which an authentication subject having succeeded in the face authentication by the face authentication unit 12 is permitted to enter. The face authentication area is an area through which the authentication subject heading toward the entry restricted area passes. The face authentication unit 12 performs the face authentication on the authentication subject, based on the image including the face authentication area. Therefore, the authentication subject does not need to stop in front of a camera. In the authentication system 1, the face authentication unit 12 performs the face authentication on the authentication subject, while the authentication subject is walking toward the entry restricted area. That is, the authentication system 1 is a system that performs walk-through face authentication.

Since the authentication subject does not need to stop for the face authentication in the walk-through face authentication, the authentication subject is able to smoothly enter the entry restricted area. On the other hand, the authentication subject has a desire to confirm whether or not he/she is permitted to enter the entry restricted area (in other words, whether or not the face authentication is successful). This is because the authentication subject may feel anxious about heading toward the entry restricted area without confirming the result of the face authentication, for example.

In the authentication system 1, the display unit 13 that displays the result of the face authentication, is disposed at least one of above the head and at the feet of the authentication subject. When the display unit 13 is disposed above the head of the authentication subject, even if there is another person to be authenticated around the authentication subject, the authentication subject is able to visually recognize the display unit 13, relatively easily. When the display unit 13 is disposed at the feet of the authentication subject, the authentication subject is also able to visually recognize the display unit 13, relatively easily. In this way, both when the display unit 13 is disposed above the head and when the display unit 13 is disposed at the feet of the authentication subject, the authentication subject is able to visually recognize the display unit 13, relatively easily. As a result, the authentication subject is able to confirm the result of his/her own face authentication, relatively easily. Therefore, according to the authentication system 1, it is possible to satisfy the above-mentioned desire of the authentication subject. As a consequence, the authentication subject is able to head toward the entry restricted area with peace of mind. This makes it possible to achieve/realize smoother entry of the authentication subject to the entry restricted area.

### Second Example Embodiment

An authentication system, an authentication method, and a recording medium according to a second example embodiment will be described with reference to FIG. 2 to FIG. 7. The following describes the authentication system, the authentication method, and the recording medium in the second example embodiment, by using an authentication system 2.

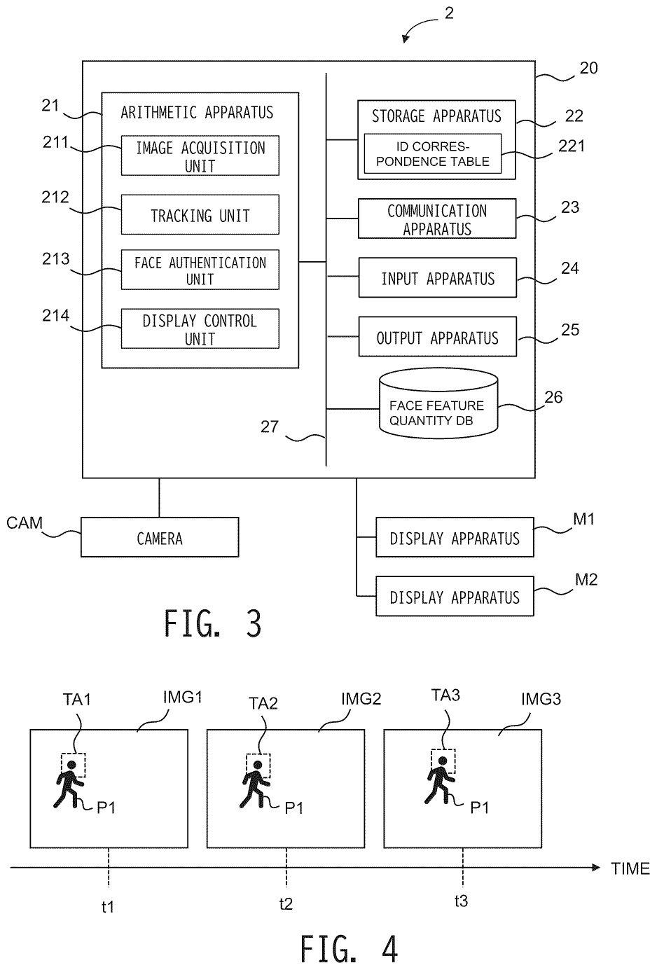

The authentication system 2 will be described with reference to FIG. 2 and FIG. 3. The authentication system 2 includes a camera CAM disposed at a gate G, display apparatuses M1 and M2, and a face authentication apparatus 20 (see FIG. 3). The authentication system 2 may include three or more display apparatuses. The authentication system 2 may include two or more cameras.

The camera CAM and the face authentication apparatus 20 are configured to communicate with each other. The display apparatuses M1 and M2 and the face authentication apparatus 20 are configured to communicate with each other. Furthermore, the communication between the camera CAM and the face authentication apparatus 20 may be wired communication or wireless communication. Similarly, the communication between the display apparatuses MI and M2 and the face authentication apparatus 20 may be wired communication or wireless communication. The wired communication conceptually includes not only communication via a network, but also communication via a cable for connecting at least one of the display apparatuses M1 and M2 and the camera CAM to the face authentication apparatus 20, such as a USB (Universal Serial Bus) cable. The wireless communication conceptually includes not only communication via a network, but also short-range wireless communication such as Bluetooth (registered trademark), for example.

In FIG. 3, the face authentication apparatus 20 includes an arithmetic apparatus 21, a storage apparatus 22, and a communication apparatus 23. The face authentication apparatus 20 may include an input apparatus 24 and an output apparatus 25. The face authentication apparatus 20 may include a face feature quantity database 26 (hereinafter referred to as a “face feature quantity DB 26”). The face authentication apparatus 20 may not include at least one of the input apparatus 24 and the output apparatus 25. In the face authentication apparatus 20, the arithmetic apparatus 21, the storage apparatus 22, the communication apparatus 23, the input apparatus 24, the output apparatus 25, and the face feature quantity DB 26 may be connected via a data bus 27. The face authentication apparatus 20 may be realized by a terminal apparatus such as, for example, a notebook-type personal computer. The face authentication apparatus 20 may be realized by a server apparatus such as, for example, a cloud server.

The arithmetic apparatus 21 may include, for example, at least one of a CPU (central processing unit), a GPU (graphics processing unit), a FPGA (Field Programmable Gate Array), a TPU (Tensor Processing Unit), and a quantum processor.

The storage apparatus 22 may include, for example, at least one of a random access memory (RAM), a read only memory (ROM), a hard disk apparatus, a magneto-optical disk apparatus, a solid state drive (SSD), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program.

The communication apparatus 23 may be configured to communicate with an apparatus external to the face authentication apparatus 20 (e.g., at least one of the camera CAM and the display apparatuses M1 and M2). The communication apparatus 23 may perform wired communication or wireless communication.

The input apparatus 24 is an apparatus that is configured to receive an input of information to the face authentication apparatus 20 from the outside. The input apparatus 24 may include an operating apparatus (e.g., a keyboard, mouse, touch panel, etc.) that is operable by an operator of the face authentication apparatus 20. The input apparatus 24 may include a recording medium reading apparatus that is configured to read information recorded on a recording medium that is attachable to or detachable from the face authentication apparatus 20, such as a USB memory. When information is inputted to the face authentication apparatus 20 via the communication apparatus 23 (in other words, when the face authentication apparatus 20 acquires information via the communication apparatus 23), the communication apparatus 23 may function as an input apparatus.

The output apparatus 25 is an apparatus that is configured to output information to the outside of the face authentication apparatus 20. The output apparatus 25 may output, as the above information, visual information such as characters and images, auditory information such as sound/audio, or tactile information such as vibration. The output apparatus 25 may include, for example, at least one of a display, a speaker, a printer, and a vibration motor. The output apparatus 25 may be configured to output information to a recording medium that is detachable from the face authentication apparatus 20, such as, for example, a USB memory. When the face authentication apparatus 20 outputs information via the communication apparatus 23, the communication apparatus 23 may function as an output apparatus.

The arithmetic apparatus 21 may include an image acquisition unit 211, a tracking unit 212, a face authentication unit 213, and a display control unit 214, as functional blocks that are logically realized, or as processing circuits that are physically realized. At least one of the image acquisition unit 211, the tracking unit 212, the face authentication unit 213, and the display control unit 214 may be realized in a mixed form of the logical functional blocks and the physical processing circuits (i.e., hardware). When at least a part of the image acquisition unit 211, the tracking unit 212, the face authentication unit 213, and the display control unit 214 is a functional block, at least the part of the image acquisition unit 211, the tracking unit 212, the face authentication unit 213, and the display control unit 214 may be realized by the arithmetic apparatus 21 executing a predetermined computer program.

The arithmetic apparatus 21 may acquire (in other words, may read) the above-mentioned predetermined computer program from the storage apparatus 22. The arithmetic apparatus 21 may read the above-mentioned predetermined computer program stored on a computer-readable and non-transitory recording medium, by using a not-illustrated recording medium reading apparatus provided in the face authentication apparatus 20. The arithmetic apparatus 21 may acquire (in other words, may downloaded or read) the above-mentioned predetermined computer program from a not-illustrated apparatus external to the face authentication apparatus 20, via the communication apparatus 23. At least one of an optical disk, a magnetic medium, a magneto-optical disk, a semiconductor memory, and any other medium configured to a program, may be used as the recording medium that records therein the above-mentioned predetermined computer program to be executed by the arithmetic apparatus 21.

In FIG. 2, on a rear side of the gate G is an entry restricted area RA. A person having succeeded in the face authentication is permitted to enter the entry restricted area RA. In other words, a person having succeeded in the face authentication is permitted to pass through the gate G. Specific examples of the entry restricted area RA may be an office security area, an area inside ticket gates at a train station, an airport security area, a paid area of a theme park, and an area in an event venue.

The camera CAM images/captures a face authentication area FRA through which multiple people heading toward the entry restricted area RA pass. By imaging the face authentication area FRA, the camera CAM generates an image including the face authentication area FRA. The image acquisition unit 211 of the face authentication apparatus 20 acquires the image generated by the camera CAM via the communication apparatus 23. The image acquisition unit 211 stores the acquired image in the storage apparatus 22. As illustrated in FIG. 2, the entry restricted area RA and the face authentication area FRA are set not to overlap.

The camera CAM may not be disposed such that the entire face authentication area FRA is included within its angle of view. In other words, the camera CAM may be disposed to image/capture at least a part of the face authentication area FRA. In this case, the authentication system 2 may include another camera, in addition to the camera CAM. That is, the authentication system 2 may include a plurality of cameras. Since the camera CAM generates images, it may also be referred to as an image generation unit.

The face authentication area FRA is a virtual area. The face authentication area FRA may be, for example, an area of 5 meters by 5 meters. A distance of 5 meters is long enough for 5 to 6 people to pass through side by side. In a case where the face authentication area FRA is an area of 5 meters by 5 meters, there may be 20 to 30 people in the face authentication area FRA.

The tracking unit 212 of the face authentication apparatus 20 performs tracking processing of tracking one or more persons passing through the face authentication area FRA, by using the image acquired by the image acquisition unit 211 (i.e., the image generated by the camera CAM). In addition, the face authentication unit 213 of the face authentication apparatus 20 performs face authentication processing on the one or more persons passing through the face authentication area FRA, by using the image acquired by the image acquisition unit 211. Since the one or more persons passing through the face authentication area FRA are target persons of the face authentication processing, they may be referred to as authentication subjects.

As a specific example of the tracking processing performed by the tracking unit 212, a case where the tracking unit 212 performs the tracking processing on a person P1, will be described with reference to FIG. 4 and FIG. 5. In addition, as a specific example of the face authentication processing performed by the face authentication unit 213, a case where the face authentication unit 213 performs the face authentication processing on the person P1, will be described. Various existing aspects (e.g., at least one of a two-dimensional (2D) authentication method and a three-dimensional (3D) authentication method) are applicable to the face authentication processing.

Images IMG1, IMG2, and IMG3 illustrated in FIG. 4 are images including the person P1 (in other words, images in which the person P1 is captured). The image IMG1 is an image generated by the camera CAM imaging the face authentication area FRA at a time t1. The image IMG2 is an image generated by the camera CAM imaging the face authentication area FRA at a time t2 that is after the time t1. The image IMG3 is an image generated by the camera CAM imaging the face authentication area FRA at a time t3 that is after the time t2.

Each of the images IMG1, IMG2, and IMG3 may be an image corresponding to one frame of a video. In this case, the image IMG2 may not be an image corresponding to a frame immediately after a frame corresponding to the image IMG1. That is, the image IMG2 may be an image corresponding to a frame existing two or more frames after the frame corresponding to image IMG1. Similarly, the image IMG3 may not be an image corresponding to a frame immediately after the frame corresponding to image IMG2. That is, the image IMG3 may be an image corresponding to a frame existing two or more frames after the frame corresponding to image IMG2.

The tracking unit 212 detects, from the image IMG1, a head of the person P1 included in the image IMG1. Since existing techniques/technologies are applicable to a method of detecting the head of a person from an image, a detailed description of the method will be omitted. Based on the detected head of the person P1, the tracking unit 212 sets an area including the head of the person P1 as a tracking area TA1.

When setting the tracking area TA1, the tracking unit 212 sets, for the person P1, a tracking ID that is identification information for identifying the person P1 relating to the tracking area TA1. The tracking unit 212 calculates a position of the person P1 (e.g., the position of the feet of the person P1), based on the tracking area TA1. Since existing techniques/technologies are applicable to a method of calculating, from the image, the position of a subject included in the image, a detailed description of the method will be omitted. The tracking unit 212 associates the tracking ID and the position of the person P1 with each other, and registers them in the ID correspondence table 221 (see FIG. 5) stored in the storage apparatus 22.

When setting the tracking area TA1, the tracking unit 212 determines whether or not the face of the person P1 is captured in the tracking area TA1. In other words, the tracking unit 212 performs face detection for the tracking area TA1. When it is determined that the face of the person P1 is captured in the tracking area TA1, the tracking unit 212 generates a face image including a face area of the person P1. The tracking unit 212 associates the generated face image with the tracking ID relating to the person P1, and transmits them to the face authentication unit 213. When it is determined that the face of the person P1 is not captured in the tracking area TA1, the tracking unit 212 may not generate the face image.

The face authentication unit 213 performs the face authentication processing, by using the face image transmitted from the tracking unit 212. Specifically, the face authentication unit 213 extracts a feature quantity of the above-mentioned face image. Since existing techniques/technologies are applicable to a method of extracting the feature quantity of the face image, a detailed description of the method will be omitted. The face authentication unit 213 collates/verifies the extracted feature quantity with a feature quantity registered in the face feature quantity DB 26. At this time, the face authentication unit 213 calculates a matching score (or a similarity score), based on the extracted feature quantity and the registered feature quantity. The face authentication unit 213 compares the matching score with a threshold. When the matching score is greater than or equal to the threshold, the face authentication unit 213 determines that the face authentication is successful. In this case, a person corresponding to the person (here, the person P1) indicated by the face image transmitted from the tracking unit 212 is identified from among multiple people registered in the face feature quantity DB 26. On the other hand, when the matching score is less than the threshold, the face authentication unit 213 determines that face authentication is failed. In this case, it is highly likely that the person corresponding to the person (here, the person P1) indicated by the face image transmitted from the tracking unit 212 is not registered in the face feature quantity DB 26.

When the face authentication is successful, the face authentication unit 213 associates an authentication ID indicating the person who corresponds to the person (here, the person P1) indicated by the face image transmitted from the tracking unit 212 and who is registered in the face feature quantity DB 26, with the tracking ID corresponding to the above face image, and registers them in the ID correspondence table 221. In addition to the authentication ID, the face authentication unit 213 may also register an authentication time that is a time at which the face authentication processing is performed, in the ID correspondence table 221. When the face authentication is failed, the face authentication unit 213 may associate information indicating that there is no applicable person (e.g., “N/A (Not Applicable)”) with to the tracking ID corresponding to the face image transmitted from the tracking unit 212, and may register it the ID correspondence table 221.

With reference to FIG. 5, the ID correspondence table 221 will be described. As illustrated in FIG. 5, in the ID correspondence table 221, the tracking ID, a tracking position (e.g., the position of the feet of the person P1), the authentication ID, and the authentication time may be associated with each other. In the ID correspondence table 221, a case where the tracking ID is associated with a specific authentication ID, indicates that a person corresponding to the person with a set tracking ID is registered in the face feature quantity DB 26. A case where the tracking ID is associated with a character string of “N/A”, indicates that the person corresponding to the person with a set tracking ID is not registered in the face feature quantity DB 26. A case where the tracking ID is not associated with the authentication ID (i.e. a case where a field of the authentication ID is blank), indicates that the face authentication processing is not performed even once.

The tracking unit 212 may identify the person P1 included in the image IMG2, by using the image IMG2 and the image IMG1. Identifying the person P1 included in the image IMG2 is synonymous with associating the person P1 included in the image IMG1 with the person P1 included in the image IMG2. Therefore, at least one of a matching method and an optical flow method relating to the association between the images, is applicable to identify the person P1 included in the image IMG2. Since various existing methods aspects are applicable to each of the matching method and the optical flow method, a detailed description of the methods will be omitted.

When the person P1 included in the image IMG2 is identified, the tracking unit 212 detects the head of the person P1. Based on the detected head of the person P1, the tracking unit 212 sets the area including the head of the person P1 as a tracking area TA2. Since the person P1 included in the image IMG1 is the same as the person P1 included in the image IMG2, the tracking ID of the person P1 relating to the tracking area TA2 is the same as the tracking ID of the person P1 relating to the tracking area TA1. The tracking unit 212 calculates the position of the person P1, based on the tracking area TA2.

The tracking unit 212 registers the position of the person P1 in the ID correspondence table 22, in association with the tracking ID relating to the person P1. In this case, since the position of the person P1 calculated based on the tracking area TAI is registered in the ID correspondence table 221, the position of the person P1 is updated, by the tracking unit 212 registering the position of the person P1 calculated based on the tracking area TA2, in the ID correspondence table 221.

When setting the tracking area TA2, the tracking unit 212 determines whether or not the face of the person P1 is captured in the tracking area TA2. In other words, the tracking unit 212 performs the face detection for the tracking area TA2. When it is determined that the face of the person P1 is captured in the tracking area TA2, the tracking unit 212 generates a face image including the face area of the person P1. The tracking unit 212 associates the generated face image with the tracking ID relating to the person P1, and transmits them to the face authentication unit 213. When it is determined that the face of the person P1 is not captured in the tracking area TA2, the tracking unit 212 may not generate the face image. Even when it is determined that the face of the person P1 is captured in the tracking area TA2, in a case where the tracking ID relating to the person P1 is associated with the authentication ID in the ID correspondence table 221 (i.e. in a case where the face authentication is already successful), the tracking unit 212 may not

The face authentication unit 213 performs the face authentication processing, by using the face image transmitted from the tracking unit 212. When the face authentication is successful, the face authentication unit 213 associates the authentication ID indicating the person who corresponds to the person (here, the person P1) indicated by the face image transmitted from the tracking unit 212 and who is registered in the face feature quantity DB 26, with the tracking ID corresponding to the above face image, and registers them in the ID correspondence table 221. In addition to the authentication ID, the face authentication unit 213 may also register the authentication time that is a time at which the face authentication processing is performed, in the ID correspondence table 221. In a case where the authentication time is already registered in the ID correspondence table 221 (i.e. in a case where the face authentication was successful in the past), the face authentication unit 213 may update the authentication time registered in the ID correspondence table 221. When the face authentication is failed, the face authentication unit 213 may associate the information indicating that there is no applicable person (e.g., “N/A”) with the tracking ID corresponding to the face image transmitted from the tracking unit 212, and may register them in the ID correspondence table 221.

The tracking unit 212 may identify the person P1 included in the image IMG3, by using the image IMG3 and the image IMG2. When the person P1 included in the image IMG3 is identified, the tracking unit 212 detects the head of the person P1. Based on the detected head of the person P1, the tracking unit 212 sets the area including the head of the person P1 as a tracking area TA3. Since the person P1 included in the image IMG2 is the same person as the person P1 included in the image IMG3, the tracking ID relating to the person P1 in the tracking area TA3 is the same as the tracking ID relating to the person P1 in the tracking area TA2. The tracking unit 212 calculates the position of the person P1, based on the tracking area TA3.

The tracking unit 212 registers the position of the person P1 in the ID correspondence table 321, in association with the tracking ID relating to the person P1. In this case, since the position of the person P1 calculated based on the tracking area TA2 is registered in the ID correspondence table 221, the position of the person P1 is updated, by the tracking unit 212 registering the position of the person P1 calculated based on the tracking area TA3, in the ID correspondence table 221.

When setting the tracking area TA3, the tracking unit 212 determines whether or not the face of the person P1 is captured in the tracking area TA3. In other words, the tracking unit 212 performs the face detection for the tracking area TA3. When it is determined that the face of the person P1 is captured in the tracking area TA3, the tracking unit 212 generates a face image including the face area of the person P1. The tracking unit 212 associates the generated face image with the tracking ID relating to the person P1 and transmits them to the face authentication unit 213. When it is determined that the face of the person P1 is not captured in the tracking area TA3, the tracking unit 212 may not generate the face image. Even when it is determined that the face of the person P1 is captured in the tracking area TA3, in a case where the tracking ID relating to the person P1 is associated with the authentication ID in the ID correspondence table 221 (i.e., in a case where the face authentication is already succeeded), the tracking unit 212 may not generate the face image.

The face authentication unit 213 performs the face authentication processing, by using the face image transmitted from the tracking unit 212. When the face authentication is successful, the face authentication unit 213 associates the authentication ID indicating the person who corresponds to the person (here, the person P1) indicated by the face image transmitted from the tracking unit 212 and who is registered in the face feature quantity DB 26, with the tracking ID corresponding to the above face image, and registers them in the ID correspondence table 221. In addition to the authentication ID, the face authentication unit 213 may also register the authentication time that is a time at which the face authentication processing is performed, in the ID correspondence table 221. In a case where the authentication time is already registered in the ID correspondence table 221 (i.e. in a case where the face authentication was successful in the past), the face authentication unit 213 may update the authentication time registered in the ID correspondence table 221. When the face authentication is failed, the face authentication unit 213 may associate the information indicating that there is no applicable person (e.g., “N/A”) with the tracking ID corresponding to the face image transmitted from the tracking unit 212, and may register them in the ID correspondence table 221.

By the way, in some cases, it is hard for the tracking unit 212 to continue tracking the person P1, for example, as the head of the passenger P1 is hidden behind others. In a case where the tracking of the person P1 is lost or interrupted, the tracking unit 212 may perform the following processing. After the tracking of the person P1 is lost or interrupted, the tracking unit 212 may determine whether or not a new person is detected from the image acquired by the image acquisition unit 211 (i.e., the image generated by the camera CAM). The “new person” means person whose tracking ID is not set yet.

When the new person is detected, the tracking unit 212 may determine whether the person P1 and the new person are the same person, by comparing the feature quantity of the tracking area (e.g., at least one of the tracking areas TA1, TA2, and TA3) relating to the person P1 with the feature quantity of the tracking area relating to the new person. When it is determined that the person P1 and the new person are the same person, the tracking unit 212 may set the tracking ID relating to the person P1, for the new person. Consequently, the tracking unit 212 may track the person P1 again. The feature quantity may be a feature quantity relating to the head of the person, a feature quantity relating to an upper body of the person, or a feature quantity relating to an entire body of the person. That is, the tracking area (e.g., at least one of the tracking areas TA1, TA2, and TA3) may include the head of the person, the upper body of the person, or entire body of the person. The feature quantity may be obtained, for example, by a Person Re-Identification technique/technology.

The tracking unit 212 and the face authentication unit 213 may repeat the above-described processing until the person P1 passes through the face authentication area FRA. The tracking unit 212 and the face authentication unit 213 may perform the above-described processing on all the persons passing through the face authentication area FRA.

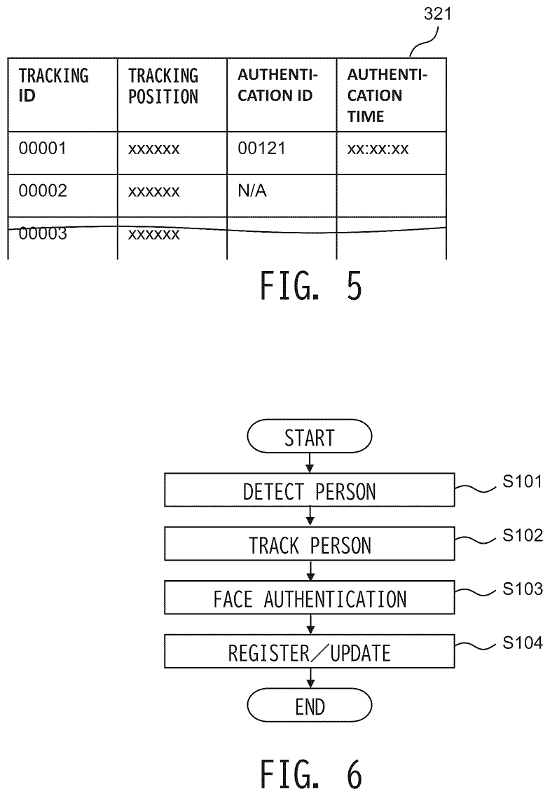

The operation of the tracking unit 212 and the face authentication unit 213 will be described with reference to a flowchart in FIG. 6. In FIG. 6, the tracking unit 212 detects one or more persons from the image acquired by the image acquisition unit 211 (i.e., the image generated by the camera CAM) (step S101). In the step S101, the tracking unit 212 may detect the head of the person. In the step S101, the tracking unit 212 may set the tracking area including the detected head of the person, based on the detected head of the person. In the step S101, the tracking unit 212 may perform the face detection on the detected one or more persons.

The tracking unit 212 performs the tracking processing on at least one of the one or more persons detected in the step S101, by using another image acquired by the image acquisition unit 211 (step S102). In the p step S102, the tracking unit 212 may perform the face detection on the detected one or more persons. When the face of at least one of the one or more persons is detected in at least one of the steps S101 and S102, the tracking unit 212 transmits the face image including the face area of at least one person, to the face authentication unit 213.

The face authentication unit 213 performs the face authentication processing, by using the face image transmitted from the tracking unit 212 (step S103). The face authentication unit 213 registers the result of the face authentication processing in the ID correspondence table 221, or updates the ID correspondence table 221 based on the result of the face authentication processing (step S104).

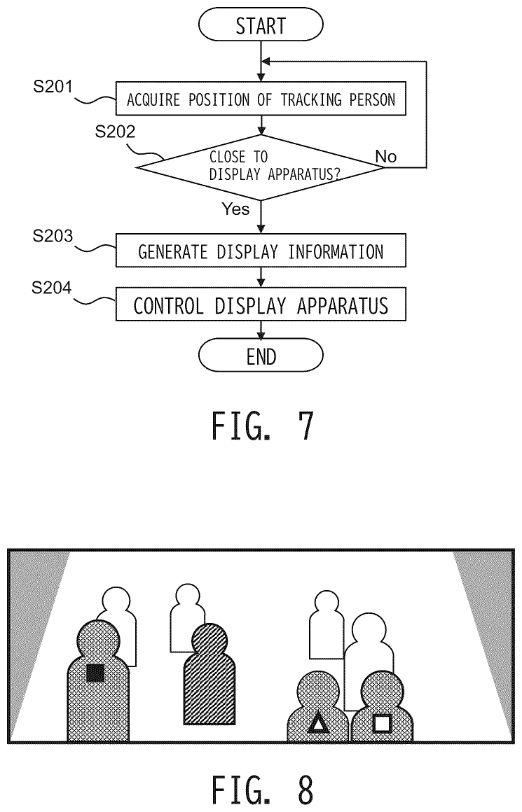

The operation of the display control unit 214 of the face authentication apparatus 20 will be described with reference to FIG. 2 and FIG. 7. In FIG. 2, a display range DR is virtually set in the vicinity of the gate G (in other words, in the vicinity of the display apparatuses M1 and M2). The display range DR is set as an area in which a person passing through the face authentication area FRA is able to visually recognize at least one of the display apparatuses M1 and M2 when the person is located in the display range DR.

In FIG. 7, the display control unit 214 acquires the position of the person passing through the face authentication area FRA (in other words, a person who is a target of the tracking processing by the tracking unit 212), based on the ID correspondence table 221 (step S201). In the step S201, when the position of the person P1 is acquired, the display control unit 214 determines whether or not the person P1 is located in the display range DR, based on the position of the person P1. In other words, the display control unit 214 determines whether or not the person P1 is close to at least one of the display apparatuses M1 and M2 (step S202).

In the step S202, when it is determined that the person P1 is not located in the display range DR, that is, when it is determined that the person P1 is not close to the display apparatuses M1 and M2 (the step S202: No), the display control unit 214 performs the step S201.

As described above, since the tracking unit 212 performs the tracking processing on the person (e.g., the person P1) passing through the face authentication area FRA, the position of the person (e.g., the person P1) registered in the ID correspondence table 221 is updated successively. In other words, the operation of the display control unit 214 illustrated in the flowchart in FIG. 7 and the operation of the tracking unit 212 and the face authentication unit 213 illustrated in the flowchart in FIG. 6 are carried out in parallel. Therefore, in the step S202, even when it is determined that the person P1 is not close to the display apparatuses M1 and M2 this time, it may be determined that the person P1 is close to at least one of the display apparatuses M1 and M2 next time.

For example, in the step S202, when it is determined that the person P1 is located in the display range DR, that is, when it is determined that the person P1 is close to at least one of the display apparatuses M1 and M2 (the step S202: No), the display control unit 214 generates display information about the person P1, based on the ID correspondence table 221 (step S203).

Specifically, in a case where the tracking ID relating to the person P1 is associated with a specific authentication ID in the ID correspondence table 221, the display control unit 214 generates display information including: information indicating a success in the face authentication; and identification information indicating the person P1. In a case where the tracking ID relating to the person P1 is associated with the character string of “N/A” in the ID correspondence table 221, the display control unit 214 generates display information including information indicating a failure in the face authentication. In this case, since the person corresponding to the person P1 is not identified by the face authentication processing, the identification information indicating the person P1 may not be included in the display information. In a case where the tracking ID relating to the person P1 is not associated with the authentication ID in the ID association table 221 (i.e., in a case where a field of the authentication ID is blank), the display control unit 214 may generate the display information including the information indicating a failure in the face authentication. In this case, the display control unit 214 may generate display information including information indicating being unauthenticated.

The display control unit 214 controls the display apparatus M1 or M2 to display the display information generated in the step S203 (step S204). The display control unit 214 determines the display apparatus that is to display the display information (one of the display apparatuses M1 and M2), based on the position in a width direction of the display range DR (i.e., a direction intersecting with a moving direction of the person heading toward the entry restricted area RA) of the person relating to the display information. As illustrated in FIG. 2, the display range DR is set next to the face authentication area FRA on a side of the entry restricted area RA not to overlap with the face authentication area RA. Therefore, the display information (e.g., the result of the face authentication) is displayed on one of the display apparatuses M1 and M2, after the person passing through the face authentication area FRA exits from the face authentication area FRA into the side of the entry restricted area RA. The display control unit 214 may perform the steps S201 to S204 on all the persons passing through the face authentication area FRA.

In FIG. 2, let us assume that persons P1, P3, and P4 are persons having succeeded in the face authentication. The person P2 is assumed to be a person having failed in the face authentication. The display control unit 214 generates, for the person P1, the display information including: information indicating a success in the face authentication; and identification information indicating the person P1. The display control unit 214 controls the display apparatus M1 such that the information indicating a success in the face authentication (e.g., a green mark) included in the display information about the person P1 is displayed in an upper left of the display apparatus M1. The display control unit 214 also controls the display apparatus MI such that the identification information indicating the person P1 (e.g., a geometric pattern) included in the display information about the person P1 is displayed in a lower left of the display apparatus M1.

The display control unit 214 generates, for the person P2, the display information including information indicating a failure in the face authentication. The display control unit 214 controls the display apparatus MI such that the information indicating a failure in the face authentication (e.g., a red mark) included in the display information about the person P2 is displayed in an upper right of the display apparatus M1.

The display control unit 214 generates, for the person P3, the display information including: information indicating a success in the face authentication; and identification information indicating the person P3. The display control unit 214 controls the display apparatus M2 such that the information indicating a success in the face authentication (e.g., a green mark) included in the display information about the person P3 is displayed in an upper left of the display apparatus M2. In addition, the display control unit 214 controls the display apparatus M2 such that the identification information indicating the person P3 (e.g., a geometric pattern) included in the display information about the person P3 is displayed in a lower left of the display apparatus M2.

The display control unit 214 generates, for the person P4, the display information including: information indicating a success in the face authentication; and identification information indicating the person P4. The display control unit 214 controls the display apparatus M2 such that the information indicating a success in the face authentication (e.g., a green mark) included in the display information about the person P4 is displayed in the upper right of the display apparatus M2. In addition, the display control unit 214 controls the display apparatus M2 such that the identification information indicating the person P4 (e.g., a geometric pattern) included in the display information about the person P4 is displayed in the lower right of the display apparatus M2.

For example, the identification information, which is a geometric pattern, may be determined when the feature quantity extracted from the face image of the person is registered in the face feature quantity DB 26. The identification information may be determined automatically by the face authentication apparatus 20, or may be determined by a person himself whose feature quantity is registered. The person whose feature quantity is registered, is notified of the determined identification information (e.g., a geometric pattern).

The display control unit 214 may generate, for a person (e.g., a person different from the persons P1 to P4), the display information including information indicating being unauthenticated. In this case, the display control unit 214 may control one of the display apparatuses M1 and M2 such that the information indicating being unauthenticated (e.g., a gray mark) is displayed on one of the display apparatuses M1 and M2. The display control unit 214 may control at least one of the display apparatuses M1 and M2 to end the display of the display information about a person having exited from the display range DR, among the persons passing through the face authentication area FRA.

As mentioned above, only the person having succeeded in the face authentication is permitted to enter the entry restricted area RA. Therefore, it can be said that the information indicating a success in the face authentication is information indicating a permission to enter the entry restricted area RA. In addition, it can be said that the information indicating a failure in the face authentication and the information indicating being unauthenticated is information indicating a denial to enter the entry restricted area RA.

### Technical Effect

The result of the face authentication (e.g., the information indicating a success in the face authentication, the information indicating a failure in the face authentication, and the information indicating being unauthenticated) is displayed on at least one of the display apparatuses MI and M2, which are disposed at a position higher than the head of the person passing through the face authentication area FRA (i.e., above the head of the person). Therefore, the person passing through the face authentication area FRA is able to visually recognize the result of the face authentication, relatively easily.

As described above, the display control unit 214 determines the display apparatus that displays the display information (one of the display apparatuses M1 and M2), based on the position in the width direction of the display range DR of the person relating to the display information including the result of the face authentication. Therefore, the result of the face authentication is displayed at a position relatively close to the person relating to the display information. Thus, the person passing through the face authentication area FRA is able to visually recognize the result of the face authentication, relatively easily.

For the person having succeeded in the face authentication, the information indicating a success in the face authentication (e.g. a mark) and the identification information (e.g. a geometric pattern) indicating the person having succeeded in the face authentication are displayed on the display apparatus M1 or M2. The person passing through the face authentication area FRA can recognize a success in the face authentication (in other words, a permission to enter the entry restricted area RA) by recognizing that his/her own identification information is displayed on display apparatus M1 or M2. In addition, the person passing through the face authentication area FRA can recognize a failure in the face authentication (in other words, a denial to enter the entry restricted area RA) by recognizing that his/her own identification information is not displayed on the display apparatuses M1 and M2.

As illustrated in FIG. 2, the display apparatuses M1 and M2 are disposed above the head of the person passing through the face authentication area FRA. The camera CAM is disposed between the display apparatuses M1 and M2. The person passing through the face authentication area FRA looks at at least one of the display apparatuses M1 and M2 to confirm the result of the face authentication. As a result, the person passing through the face authentication area FRA naturally looks at the camera CAM. This makes it easier to detect the face area of the person passing through the face authentication area FRA, in the tracking processing performed by the tracking unit 212. Therefore, the face authentication unit 213 is allowed to properly perform the face authentication on the person passing through the face authentication area FRA.

### Modification

As illustrated in FIG. 8, the display control unit 214 may control at least one of the display apparatuses M1 and M2 to display a human figure corresponding to the person passing through the face authentication area FRA. In this case, the display control unit 214 may control at least one of the display apparatuses M1 and M2 such that a green human figure is displayed for the person having succeeded in the face authentication. In this case, the display control unit 214 may control at least one of the display apparatuses M1 and M2 such that the identification information (e.g., a geometric pattern) indicating the person having succeeded in the face authentication is displayed in the green human figure. The display control unit 214 may control at least one of the display apparatuses M1 and M2 such that a red human figure is displayed for the person having failed in the face authentication. The display control unit 214 may control at least one of the display apparatuses M1 and M2 such that a gray human figure is displayed for an unauthenticated person.

The display control unit 214 may determine a position and a size of the human figure, based on a position and a size of each person included in the image generated by the camera CAM (i.e., each person passing through the face authentication area FRA). The size of each person included in the above image may be expressed as the number of pixels of each person in the above image. The display control unit 214 may calculate or estimate a distance of each person included in the above image from the camera CAM, the gate G, or the entry restricted area RA. The display control unit 214 may determine the size of the human figure corresponding to each person, based on the calculated or estimated distance.

The display control unit 214 may set a color of the human figure corresponding to a person located close to at least one of the display apparatuses M1 and M2 (or one of the cameras CAM, the gate, and the entry restricted area RA) among the persons passing through the face authentication area FRA, to be darker than that of the human figure corresponding to a person located far from the display apparatuses M1 and M2, based on the ID correspondence table 221.

In addition to the color shades of the human figure, the display control unit 214 may also change transparency of the human figure. In this case, the display control unit 214 may set the transparency of the human figure corresponding to the person located far from the display apparatuses M1 and M2 among the persons passing through the face authentication area FRA, to be greater than that of the human figure corresponding to the person located close to at least one of the display apparatuses M1 and M2 (or one of the cameras CAM, the gate, and the entry restricted area RA). That is, the display control unit 214 may set greater opacity of the human figure corresponding to the person located close to at least one of the display apparatuses MI and M2 (or one of the cameras CAM, the gate, and the entry restricted area RA).

The display control unit 214 may control at least one of the display apparatuses MI and M2 to change the position of the human figure displayed on at least one of the display apparatuses M1 and M2, depending on a trajectory of the corresponding person, based on the ID correspondence table 221. In this case, the display control unit 214 may control at least one of the display apparatuses M1 and M2 to display the above trajectory.

The display control unit 214 may control at least one of the display apparatuses MI and M2 such that the human figure corresponding to the person located close to at least one of the display apparatuses M1 and M2 among the persons passing through the face authentication area FRA is displayed in front of the human figure corresponding to the person located far from the display apparatuses M1 and M2. In this case, the human figure corresponding to the person moving closer to at least one of the display apparatuses M1 and M2, moves from a rear side to a front side of a screen, on at least one of the display apparatuses M1 and M2.

The display control unit 214 may control at least one of the display apparatuses MI and M2 such that the human figure corresponding to the person located close to at least one of the display apparatuses M1 and M2 among the persons passing through the face authentication area FRA is displayed in the rear of the human figure corresponding to the person located far from the display apparatuses M1 and M2. In this case, the human figure corresponding to the people moving closer to at least one of the display apparatuses M1 and M2, moves from the front side to the rear side of the screen, on at least one of the display apparatuses M1 and M2.

Instead of displaying the human figure corresponding to the person passing through the face authentication area FRA (see FIG. 8), the display control unit 214 may control at least one of the display apparatuses M1 and M2 to display the image including the face authentication area FRA generated by the camera CAM. In this case, the display control unit 214 may control at least one of the display apparatuses M1 and M2 such that a green frame is superimposed on the person having succeeded in the face authentication included in the above image. The display control unit 214 may control at least one of the display apparatuses M1 and M2 such that a red frame is superimposed on the person having failed in the face authentication included in the above image. The display control unit 214 may control at least one of the display apparatuses M1 and M2 such that a gray frame is superimposed on the unauthenticated person included in the above image.

The authentication ID may be linked to an email address of the person associated with the authentication ID. The face authentication apparatus 20 may send an email indicating a success in the face authentication, via the communication apparatus 23, to the email address linked to the authentication ID associated with the person having succeeded in the face authentication, among the persons passing through the face authentication area FRA.

### Third Example Embodiment

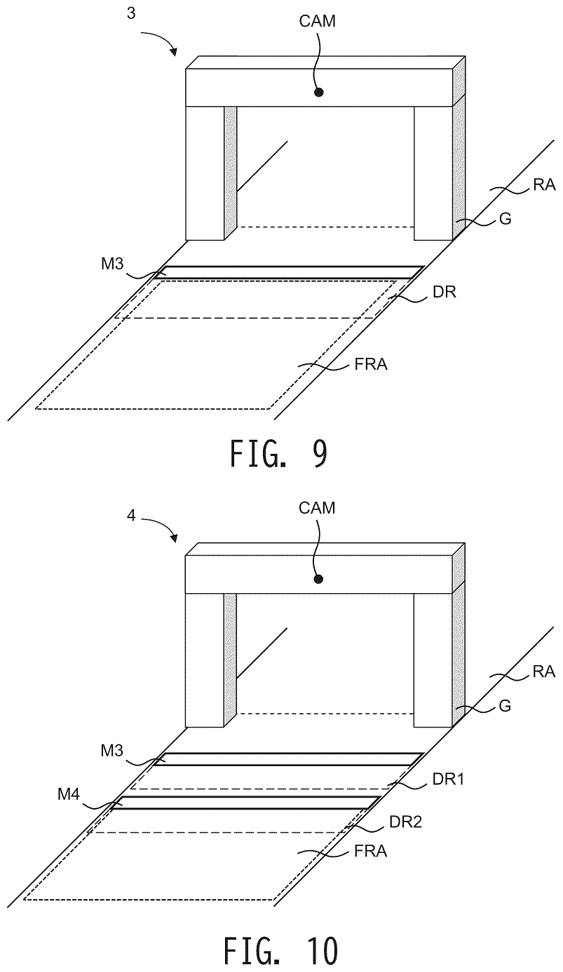

An authentication system, an authentication method, and a recording medium according to a third example embodiment will be described with reference to FIG. 9. The following describes the authentication system, the authentication method, and the recording medium in the third example embodiment, by using an authentication system 3. For convenience, the illustration of the person passing through the face authentication area FRA is omitted in FIG. 9.

The authentication system 3 will be described with reference to FIG. 9. The authentication system 3 includes the camera CAM disposed at the gate G, a display apparatus M3, and the face authentication apparatus 20 (see FIG. 3). The display apparatus M3 and the face authentication apparatus 20 are configured to communicate with each other. The communication between the display apparatus M3 and the face authentication apparatus 20 may be wired communication or wireless communication. An overlapping description of the camera CAM and the face authentication apparatus 20 with that of the second example embodiment will be omitted.

The display apparatus M3 is disposed at the feet of the person passing through the face authentication area FRA. As illustrated in FIG. 9, the display apparatus M3 extends in a direction intersecting with a moving direction of the person passing through the face authentication area FRA. The display apparatus M3 may be disposed at a position corresponding to an edge on the side of the entry restricted area RA of the face authentication area FRA. The display apparatus M3 may include a LED (light emitting diode) tape.

The operation of the display control unit 214 of the face authentication apparatus 20 will be described. In FIG. 9, the display range DR is virtually set in the vicinity of the gate G (in other words, in the vicinity of the display apparatus M3). The display range DR is set as an area in which the person passing through the face authentication area FRA is able to visually recognize the display apparatus M3 when the person is located in the display range DR.

The display control unit 214 acquires the position of the person passing through the face authentication area FRA (in other words, the person who is a target of the tracking processing by the tracking unit 212), based on the ID correspondence table 221. For example, when the position of the person P1 is acquired, the display control unit 214 determines whether or not the person P1 is located in the display range DR, based on the position of the person P1. In other words, the display control unit 214 determines whether or not the person P1 is close to the display apparatus M3.

For example, when it is determined that the person P1 is located in the display range DR, that is, when it is determined that the person P1 is close to the display apparatus M3, the display control unit 214 generates the display information about the person P1, based on the ID correspondence table 221.

Specifically, in a case where the tracking ID relating to the person P1 is associated with a specific authentication ID in the ID correspondence table 221, the display control unit 214 generates the display information including information indicating a success in the face authentication. In a case where the tracking ID relating to the person P1 is associated with the character string of “N/A” in the ID correspondence table 221, the display control unit 214 generates the display information including information indicating a failure in the face authentication. In a case where the tracking ID relating to the person P1 is not associated with the authentication ID in the ID association table 221 (i.e., in a case where a field of the authentication ID is blank), the display control unit 214 may generate the display information including the information indicating a failure in the face authentication. In this case, the display control unit 214 may generate the display information including information indicating being unauthenticated.

The display control unit 214 controls the display apparatus M3 to display the generated display information. The display control unit 214 determines a display position of the display information on the display apparatus M3, based on the position in the width direction of the display range DR (i.e., the direction intersecting with the moving direction of the person heading toward the entry restricted area RA) of the person relating to the display information.

For example, in a case where the person P1 is the person having succeeded in the face authentication, the display control unit 214 generates the display information including information indicating a success in the face authentication. The display control unit 214 controls the display apparatus M3 such that the information indicating a success in the face authentication included in the display information is displayed at the display position of the display information on the display apparatus M3, which is determined based on the position in the width direction of the display range DR of the person P1. In a case where the display apparatus M3 includes the LED tape, the display control unit 214 may control the display apparatus M3 such that the LED disposed at the display position emits green light.

For example, in a case where the person P1 is the person having failed in the face authentication, the display control unit 214 generates the display information including information indicating a failure in the face authentication. The display control unit 214 controls the display apparatus M3 such that the information indicating a failure in the face authentication included in the display information is displayed at the display position of the display information on the display apparatus M3, which is determined based on the position in the width direction of the display range DR of the person P1. In a case where the display apparatus M3 includes the LED tape, the display control unit 214 may control the display apparatus M3 such that the LED disposed at the above display position emits red light.

For example, in a case where the person P1 is the unauthenticated person, the display control unit 214 generates the display information including information indicating being unauthenticated. The display control unit 214 controls the display apparatus M3 such that the information indicating being unauthenticated included in the display information is displayed at the display position of the display information on the display apparatus M3, which is determined based on the position in the width direction of the display range DR of the person P1. In a case where the display apparatus M3 includes the LED tape, the display control unit 214 may control the display apparatus M3 such that the LED disposed at the display position emits gray light.

For example, when the person P1 exits from the display range DR, the display control unit 214 controls the display apparatus M3 to end the display of the display information about the person P1. The display control unit 214 may perform the above-described processing on all the persons passing through the face authentication area FRA.

### Technical Effect

The result of the face authentication (e.g., the information indicating a success in the face authentication, the information indicating a failure in the face authentication, and the information indicating being unauthenticated) is displayed near the feet of the person associated with the result of the face authentication. Therefore, the person passing through the face authentication area FRA is able to visually recognize the result of the face authentication, relatively easily. In addition, since the display information displayed on the display apparatus M3 varies depending on the result of the face authentication, the person passing through the face authentication area FRA is able to recognize whether or not the person has succeeded in the face authentication (in other words, whether or not the person is permitted to enter the entry restricted area RA).

### Modification

In FIG. 9, the display apparatus M3 extends linearly in the direction intersecting with the moving direction of the person passing through the face authentication area FRA. The display apparatus M3, however, may be disposed in an arc shape to intersect with the moving direction of the person passing through the face authentication area FRA. In this configuration, for example, even if a width of the gate G is different from a width of a passage, it is possible to properly display the result of the face authentication on the display apparatus M3. It is also possible to improve a degree of freedom in the layout of the gate G.

The display apparatus M3 may include a display. In this case, as in the second example embodiment described above, the display control unit 214 may control the display apparatus M3 to display, for the person having succeeded in the face authentication, the information indicating a success in the face authentication (e.g., a green mark) and the information indicating the person.

The authentication ID may be linked to an email address of the person associated with the authentication ID. The face authentication apparatus 20 may send an email indicating a success in the face authentication, via the communication apparatus 23, to the email address linked to the authentication ID associated with the person having succeeded in the face authentication, among the persons passing through the face authentication area FRA.

### Fourth Example Embodiment

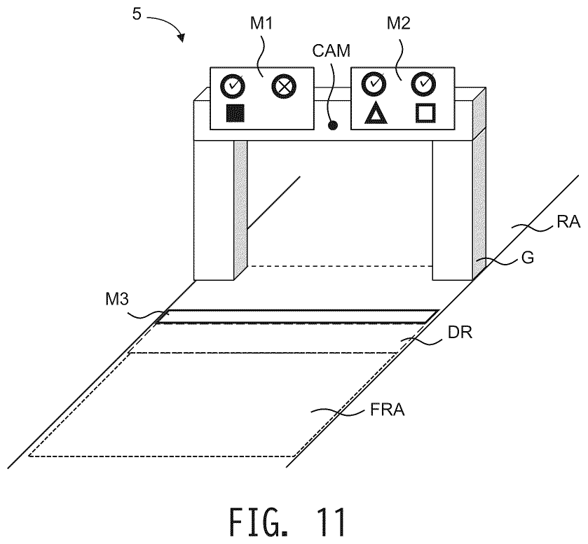

An authentication system, an authentication method, and a recording medium according to a fourth example embodiment will be described with reference to FIG. 10. The following describes the authentication system, the authentication method, and the recording medium in the fourth example embodiment, by using an authentication system 4. For convenience, the illustration of the person passing through the face authentication area FRA is omitted in FIG. 10.

The authentication system 4 will be described with reference to FIG. 10. The authentication system 4 includes the camera CAM disposed at the gate G, display apparatuses M3 and M4, and the face authentication apparatus 20 (see FIG. 3). The display apparatuses M3 and M4 and the face authentication apparatus 20 are configured to communicate with each other. The communication between the display apparatuses M3 and M4 and the face authentication apparatus 20 may be wired communication or wireless communication. An overlapping description of the camera CAM and the face authentication apparatus 20 with that of the second example embodiment will be omitted.

The display apparatus M3 is disposed at the feet of the person passing through the face authentication area FRA. As illustrated in FIG. 10, the display apparatus M3 extends in a direction intersecting with the moving direction of the person passing through the face authentication area FRA. The display apparatus M3 may be disposed at the position corresponding to the edge on the side of the entry restricted area RA of the face authentication area FRA. The display apparatus M4 is disposed at the feet of the person passing through the face authentication area FRA. As illustrated in FIG. 10, the display apparatus M4 extends in a direction intersecting with the moving direction of the person passing through the face authentication area FRA. As illustrated in FIG. 10, the display apparatuses M3 and M4 are arranged at intervals along the moving direction of the person passing through the face authentication area FRA. The display apparatuses M3 and M4 may include the LED tape.

The operation of the display control unit 214 of the face authentication apparatus 20 will be described. In FIG. 10, a display range DR1 is virtually set in the vicinity of the display apparatus M3. In addition, a display range DR2 is virtually set in the vicinity of the display apparatus M4. The display range DR1 is set as an area in which the person passing through the face authentication area FRA is able to visually recognize the display apparatus M3 when the person is located in the display range DR1. The display range DR2 is set as an area in which the person passing through the face authentication area FRA is able to visually recognize the display apparatus M4 when the person is located in the display range DR2.

The display control unit 214 acquires the position of the person passing through the face authentication area FRA (in other words, the person who is a target of the tracking processing by the tracking unit 212), based on the ID correspondence table 221. For example, when the position of the person P1 is acquired, the display control unit 214 determines whether or not the person P1 is located in the display range DR2, based on the position of the person P1. In other words, the display control unit 214 determines whether or not the person P1 is close to the display apparatus M4.

For example, when it is determined that the person P1 is located in the display range DR2, that is, when it is determined that the person P1 is close to the display apparatus M4, the display control unit 214 generates the display information about the person P1, based on the ID correspondence table 221.

Specifically, in a case where the tracking ID relating to the person P1 is associated with a specific authentication ID in the ID correspondence table 221, the display control unit 214 generates the display information including information indicating a success in the face authentication. In a case where the tracking ID relating to the person P1 is associated with the character string of “N/A” in the ID correspondence table 221, the display control unit 214 generates the display information including information indicating a failure in the face authentication. In a case where the tracking ID relating to the person P1 is not associated with the authentication ID in the ID association table 221 (i.e., in a case where a field of the authentication ID is blank), the display control unit 214 may generate the display information including the information indicating a failure in the face authentication. In this case, the display control unit 214 may generate the display information including information indicating being unauthenticated.

The display control unit 214 controls the display apparatus M4 to display the generated display information. The display control unit 214 determines a display position of the display information on the display apparatus M4, based on the position in a width direction of the display range DR2 (i.e., a direction intersecting with the moving direction of the person heading toward the entry restricted area RA) of the person relating to the display information.

For example, in a case where the person P1 is the person having succeeded in the face authentication, the display control unit 214 generates the display information including information indicating a success in the face authentication. The display control unit 214 controls the display apparatus M4 such that the information indicating a success in the face authentication included in the display information is displayed at the display position of the display information on the display apparatus M4, which is determined based on the position in the width direction of the display range DR2 of the person P1. In a case where the display apparatus M4 includes the LED tape, the display control unit 214 may control the display apparatus M4 such that the LED disposed at the display position emits green light.

For example, in a case where the person P1 is the person having failed in the face authentication, the display control unit 214 generates the display information including information indicating a failure in the face authentication. The display control unit 214 controls the display apparatus M4 such that the information indicating a failure in the face authentication included in the display information is displayed at the display position of the display information on the display apparatus M4, which is determined based on the position in the width direction of the display range DR2 of the person P1. In a case where the display apparatus M4 includes the LED tape, the display control unit 214 may control the display apparatus M4 such that the LED disposed at the above display position emits red light.

For example, in a case where the person P1 is the unauthenticated person, the display control unit 214 generates the display information including information indicating being unauthenticated. The display control unit 214 controls the display apparatus M4 such that the information indicating being unauthenticated included in the display information is displayed at the display position of the display information on the display apparatus M4, which is determined based on the position in the width direction of the display range DR2 of the person P1. In a case where the display apparatus M4 includes the LED tape, the display control unit 214 may control the display apparatus M4 such that the LED disposed at the display position emits gray light.

For example, when the person P1 exits from the display range DR2, the display control unit 214 controls the display apparatus M4 to end the display of the display information about the person P1. Thereafter, the display control unit 214 determines whether or not the person P1 is located in the display range DR1, based on the position of the person P1 based on the ID correspondence table 221. In other words, the display control unit 214 determines whether or not the person P1 is close to the display apparatus M3.

For example, when it is determined that the person P1 is located in the display range DR1, that is, when it is determined that the person P1 is close to the display apparatus M3, the display control unit 214 generates the display information about the person P1, based on the ID correspondence table 221.

The display control unit 214 controls the display apparatus M3 to display the generated display information. The display control unit 214 determines the display position of the display information on the display apparatus M3, based on the position in the width direction of the display range DR2 (i.e., the direction intersecting with the moving direction of the person heading toward the entry restricted area RA) of the person relating to the display information.

For example, in a case where the person P1 is the person having succeeded in the face authentication, the display control unit 214 generates the display information including information indicating a success in the face authentication. The display control unit 214 controls the display apparatus M3 such that the information indicating a success in the face authentication included in the display information is displayed at the display position of the display information on the display apparatus M3, which is determined based on the position in the width direction of the display range DR1 of the person P1. In a case where the display apparatus M3 includes the LED tape, the display control unit 214 may control the display apparatus M3 such that the LED disposed at the display position emits green light.

For example, in a case where the person P1 is the person having failed in the face authentication, the display control unit 214 generates the display information including information indicating a failure in the face authentication. The display control unit 214 controls the display apparatus M3 such that the information indicating a failure in the face authentication included in the display information is displayed at the display position of the display information on the display apparatus M3, which is determined based on the position in the width direction of the display range DR1 of the person P1. In a case where the display apparatus M3 includes the LED tape, the display control unit 214 may control the display apparatus M3 such that the LED disposed at the above display position emits red light.

For example, in a case where the person P1 is the unauthenticated person, the display control unit 214 generates the display information including information indicating being unauthenticated. The display control unit 214 controls the display apparatus M3 such that the information indicating being unauthenticated included in the display information is displayed at the display position of the display information on the display apparatus M3, which is determined based on the position in the width direction of the display range DR1 of the person P1. In a case where the display apparatus M3 includes the LED tape, the display control unit 214 may control the display apparatus M3 such that the LED disposed at the display position emits gray light.

For example, when the person P1 exits from the display range DR1, the display control unit 214 controls the display apparatus M3 to end the display of the display information about the person P1. The display control unit 214 may perform the above-described processing on all the persons passing through the face authentication area FRA.

### Technical Effect

The result of the face authentication (e.g., the information indicating a success in the face authentication, the information indicating a failure in the face authentication, and the information indicating being unauthenticated) is displayed near the feet of the person associated with the result of the face authentication. Therefore, the person passing through the face authentication area FRA is able to visually recognize the result of the face authentication, relatively easily. Especially in the present example embodiment, the result of the face authentication is displayed on display apparatus M4, and therefore, the person having failed in the face authentication is able to become aware that the person is not permitted to enter the entry restricted area RA, relatively early.

### Modification

A display color of the information indicating a failure in the face authentication displayed on the display apparatus M4 may be a color that is less alarming than a display color of the information indicating a failure in the face authentication displayed on display apparatus M3. For example, in a case where the display color of the information indicating a failure in the face authentication displayed on display apparatus M3 is red, the display color of the information indicating a failure in the face authentication displayed on display apparatus M4 may be orange or yellow.

As in the third example embodiment described above, at least one of the display apparatuses M3 and M4 may be disposed in an arc shape to intersect with the moving direction of the person passing through the face authentication area FRA. At least one of the display apparatuses M3 and M4 may include a display. The authentication ID may be linked to an email address of the person associated with the authentication ID. The face authentication apparatus 20 may send an email indicating a success in the face authentication, via the communication apparatus 23, to the email address linked to the authentication ID associated with the person having succeeded in the face authentication, among the persons passing through the face authentication area FRA.

### Fifth Example Embodiment

An authentication system, an authentication method, and a recording medium according to a fifth example embodiment will be described with reference to FIG. 11. The following describes the authentication system, the authentication method, and the recording medium in the fifth example embodiment, by using an authentication system 4. For convenience, the illustration of the person passing through the face authentication area FRA is omitted in FIG. 11.

The authentication system 5 will be described with reference to FIG. 11. The authentication system 5 includes the camera CAM disposed at the gate G, the display apparatuses M1, M2, and M3, and the face authentication apparatus 20 (see FIG. 3). The display apparatuses M1, M2, and M3 and the face authentication apparatus 20 are configured to communicate with each other. The communication between the display apparatuses M1, M2, and M3 and the face authentication apparatus 20 may be wired communication or wireless communication. An overlapping description of the camera CAM and the face authentication apparatus 20 with that of the second example embodiment will be omitted.

The display apparatus M3 is disposed at the feet of the person passing through the face authentication area FRA. As illustrated in FIG. 11, the display apparatus M3 extends in a direction intersecting with the moving direction of the person passing through the face authentication area FRA. The display apparatus M3 may be disposed at the position corresponding to the edge on the side of the entry restricted area RA of the face authentication area FRA. The display apparatus M3 may include the LED tape.

The operation of the display control unit 214 of the face authentication apparatus 20 will be described. In FIG. 11, the display range DR is virtually set in the vicinity of the gate G. The display range DR is set as an area in which the person passing through the face authentication area FRA is able to visually recognize at least one of the display apparatuses M1, M2, and M3 when the person is located in the display range DR.

The display control unit 214 acquires the position of the person passing through the face authentication area FRA (in other words, the person who is a target of the tracking processing by the tracking unit 212), based on the ID correspondence table 221. For example, when the position of the person P1 is acquired, the display control unit 214 determines whether or not the person P1 is located in the display range DR, based on the position of the person P1. In other words, the display control unit 214 determines whether or not the person P1 is close to at least one of the display apparatuses M1, M2, and M3.

For example, when it is determined that the person P1 is located in the display range DR, that is, when it is determined that the person P1 is close to at least one of the display apparatuses M1, M2, and M3, the display control unit 214 generates the display information about the person P1, based on the ID correspondence table 221.

Specifically, in a case where the tracking ID relating to the person P1 is associated with a specific authentication ID in the ID correspondence table 221, the display control unit 214 generates the display information including: information indicating a success in the face authentication; and information indicating the person P1. In a case where the tracking ID relating to the person P1 is associated with the character string of “N/A” in the ID correspondence table 221, the display control unit 214 generates the display information including information indicating a failure in the face authentication. In a case where the tracking ID relating to the person P1 is not associated with the authentication ID in the ID association table 221 (i.e., in a case where a field of the authentication ID is blank), the display control unit 214 may generate the display information including the information indicating a failure in the face authentication. In this case, the display control unit 214 may generate the display information including information indicating being unauthenticated.

The display control unit 214 controls the display apparatus M3 and at least one of the display apparatuses M1 and M2 to display the generated display information. The display control unit 214 determines the display position of the display information on the display apparatus M3 and at least one of the display apparatuses M1 and M2, based on the position in the width direction of the display range DR (i.e., the direction intersecting with the moving direction of the person heading toward the entry restricted area RA) of the person relating to the display information.

For example, in a case where the person P1 is the person having succeeded in the face authentication, the display control unit 214 generates the display information including: information indicating a success in the face authentication; and information indicating the person P1. The display control unit 214 controls one of the display apparatuses M1 and M2 such that the information indicating a success in the face authentication (e.g., a green mark) included in the display information about the person P1 is displayed on one of the display apparatuses M1 and M2. In addition, the display control unit 214 controls one of the display apparatuses M1 and M2 such that the identification information indicating the person PI (e.g., a geometric pattern) included in the display information about the person P1 is displayed on one of the display apparatuses M1 and M2. The display control unit 214 controls the display apparatus M3 such that the information indicating a success in the face authentication included in the display information is displayed at the display position of the display information on the display apparatus M3, which is determined based on the position in the width direction of the display range DR of the person P1. In a case where the display apparatus M3 includes the LED tape, the display control unit 214 may control the display apparatus M3 such that the LED disposed at the display position emits green light.

For example, in a case where the person P1 is the person having failed in the face authentication, the display control unit 214 generates the display information including information indicating a failure in the face authentication. The display control unit 214 controls one of the display apparatuses M1 and M2 such that the information indicating a failure in the face authentication (e.g., a red mark) included in the display information about the person P1 is displayed on one of the display apparatuses M1 and M2. The display control unit 214 controls the display apparatus M3 such that the information indicating a failure in the face authentication included in the display information is displayed at the display position of the display information on the display apparatus M3, which is determined based on the position in the width direction of the display range DR of the person P1. In a case where the display apparatus M3 includes the LED tape, the display control unit 214 may control the display apparatus M3 such that the LED disposed at the display position emits red light.

For example, in a case where the person P1 is the unauthenticated person, the display control unit 214 generates the display information including information indicating being unauthenticated. The display control unit 214 controls one of the display apparatuses MI and M2 such that the information indicating being unauthenticated (e.g., a gray mark) included in the display information about the person P1 is displayed on one of the display apparatuses M1 and M2. The display control unit 214 controls the display apparatus M3 such that the information indicating being unauthenticated included in the display information is displayed at the display position of the display information on the display apparatus M3, which is determined based on the position in the width direction of the display range DR of the person P1. In a case where the display apparatus M3 includes the LED tape, the display control unit 214 may control the display apparatus M3 such that the LED disposed at the display position emits gray light.

The display control unit 214 may change display order of the display apparatus M3 and one of the display apparatuses M1 and M2. For example, when the person P1 enters the display range DR, the display control unit 214 may first control the display apparatus M3 such that the result of the face authentication of the person P1 is displayed on the display apparatus M3. After the result of the face authentication of the person P1 is displayed on the display apparatus M3, the display control unit 214 may control one of the display apparatuses M1 and M2 such that the result of the face authentication of the person P1 is displayed on one of the display apparatuses MI and M2. In this configuration, after the person P1 confirms the result of the face authentication displayed on the display apparatus M3, the person P1 is able to confirm again the result of the face authentication displayed on one of the display apparatuses M1 and M2. As a result, it is possible to enhance a sense of security of the person P1.

The display control unit 214 may change the display order of the display apparatus M3 and one of the display apparatuses M1 and M2, based on the result of the face authentication of the person P1 by the face authentication unit 213. In a case where the person P1 is the person having failed in the face authentication or the unauthenticated person, there is a high possibility that the person P1 is not facing/looking at the camera CAM (in this case, there is a high possibility that the person P1 is looking at the feet). In this case, the display control unit 214 may control the display apparatus M3 such that the result of the face authentication of the person P1 is first displayed on the display apparatus M3 when the person P1 enters the display range DR. After the result of the face authentication of the person P1 is displayed on the display apparatus M3, the display control unit 214 may control one of the display apparatuses M1 and M2 such that the result of the face authentication of the person P1 is displayed on one of the display apparatuses M1 and M2. In this configuration, it is possible to make the person P1, who is the person having failed in the face authentication or the unauthenticated person, be aware of the result of his/her own face authentication.

In a case where the person P1 is the person having succeeded in the face authentication, there is a high possibility that the person P1 is facing/looking at the camera CAM (in other words, there is a high possibility that the person P1 is facing the face forward or diagonally upward). In this case, the display control unit 214 may control one of the display apparatuses M1 and M2 such that the result of the face authentication of the person P1 is first displayed on one of the display apparatuses M1 and M2 when the person P1 enters the display range DR. After the result of the face authentication of the person P1 is first displayed on one of the display apparatuses M1 and M2, the display control unit 214 may control the display apparatus M3 such that the result of the face authentication of the person P1 is displayed on the display apparatus M3. In this configuration, the person P1, who is the person having succeeded in the face authentication, easily becomes aware of the result of the face authentication.

For example, when the person P1 exits from the display range DR, the display control unit 214 controls the display apparatus M3 and one of the display apparatuses M1 and M2 to end the display of the display information about the person P1. The display control unit 214 may perform the above-described processing on all the persons passing through the face authentication area FRA.

### Technical Effect

The result of the face authentication (e.g., the information indicating a success in the face authentication, the information indicating a failure in the face authentication, and the information indicating being unauthenticated) is displayed on at least one of the display apparatuses M1 and M2 disposed above the head of the person passing through the face authentication area FRA, and on the display apparatus M3 disposed at the feet of the person. Therefore, the person passing through the face authentication area FRA is able to visually recognize the result of the face authentication, relatively easily.

### Modification

The authentication system 5 may adopt various aspects that are similar to or the same as those according to the modification of the second example embodiment. The authentication system 5 may adopt various aspects that are similar to or the same as those according to the modification of the third example embodiment. In addition to the display apparatuses M1, M2, and M3, the authentication system 5 may also include a display apparatus corresponding to the display apparatus M4 according to the fourth example embodiment.

The authentication system related to this disclosure is not limited to the example embodiments described above. The above-mentioned example embodiments and modifications may be combined as appropriate, without departing from the essence or spirit of the invention which can be read from this disclosure.

### SUPPLEMENTARY NOTES

With respect to the example embodiment described above, the following Supplementary Notes are further disclosed.

### Supplementary Note 1

An Authentication System Including:
an image acquisition unit that acquires an image including a face authentication area through which an authentication subject heading toward an entry restricted area passes;
a face authentication unit that performs face authentication on the authentication subject, based on the acquired image; and
a display unit that is disposed at least one of above a head and at feet of the authentication subject, and that displays a result of the face authentication after the authentication subject exits from the face authentication area on the entry restricted area side.

### Supplementary Note 2

The authentication system according to Supplementary Note 1, wherein the result of the face authentication includes a first result indicating that the authentication subject is permitted to enter the entry restricted area, and a second result indicating that the authentication subject is not permitted to enter the entry restricted area.

### Supplementary Note 3

The authentication system according to Supplementary Note 1 or 2, wherein the display unit displays the result of the face authentication together with information indicating the authentication subject.

### Supplementary Note 4

The authentication system according to Supplementary Note 3, wherein the information indicating the authentication subject is a geometric pattern.

### Supplementary Note 5

The authentication system according to Supplementary Note 1 or 2, wherein the display unit displays the result of the face authentication, by changing a display color of a human figure corresponding to the authentication subject, based on the result of the face authentication.

### Supplementary Note 6

The authentication system according to any one of Supplementary Notes 1 to 5, wherein
the display unit includes a first display apparatus and a second display apparatus,
the first display apparatus and the second display apparatus are arranged side by side above the head of the authentication subject, and
an imaging unit that images the authentication subject is disposed between the first display apparatus and the second display apparatus.

### Supplementary Note 7

The authentication system according to any one of Supplementary Notes 1 to 6, wherein
the display unit includes a third display apparatus disposed at the feet of the authentication subject, and
the third display apparatus extends in a direction intersecting with a moving direction of the authentication subject.

### Supplementary Note 8

The authentication system according to Supplementary Note 7, wherein the third display apparatus is a LED tape.

### Supplementary Note 9

The authentication system according to Supplementary Note 7 or 8, wherein
the display unit includes a fourth display apparatus disposed at the feet of the authentication subject,
the third display apparatus extends in a direction intersecting with a moving direction of the authentication subject, and
the third display apparatus and the fourth display apparatus are arranged at intervals along the moving direction of the authentication subject.

### Supplementary Note 10

The authentication system according to any one of Supplementary Notes 1 to 9, wherein the display unit is disposed between the entry restricted area and the face authentication area.

### Supplementary Note 11

The authentication system according to any one of Supplementary Notes 1 to 10, wherein the display unit is disposed at a position corresponding to an edge on the side of the entry restricted area of the face authentication area.

### Supplementary Note 12

The authentication system according to any one of Supplementary Notes 1 to 11, wherein the face authentication area is disposed in front of the entry restricted area in a moving direction of the authentication subject heading toward the entry restricted area.

### Supplementary Note 13

The authentication system according to any one of Supplementary Notes 1 to 12, wherein
the display unit includes a first display apparatus disposed above the head of the authentication subject and a third display apparatus disposed at the feet of the authentication subject, and
the display unit changes order of displaying the result of the face authentication on the first display apparatus and the third display apparatus, based on the result of the face authentication.

### Supplementary Note 14

An authentication method including:
acquiring an image including a face authentication area through which an authentication subject heading toward an entry restricted area passes;
performing face authentication on the authentication subject, based on the acquired image; and
displaying a result of the face authentication at least one of above a head and at feet of the authentication subject, after the authentication subject exits from the face authentication area on the entry restricted area side.

### Supplementary Note 15

A recording medium on which a computer program that allows a computer to execute an authentication method is recorded, the authentication method including:
acquiring an image including a face authentication area through which an authentication subject heading toward an entry restricted area passes;
performing face authentication on the authentication subject, based on the acquired image; and
displaying a result of the face authentication at least one of above a head and at feet of the authentication subject, after the authentication subject exits from the face authentication area on the entry restricted area side.

### Supplementary Note 16

An authentication apparatus including:
an image acquisition unit that acquires an image including a face authentication area through which an authentication subject heading toward an entry restricted area passes;
a face authentication unit that performs face authentication on the authentication subject, based on the acquired image; and
a display unit that displays a result of the face authentication at least one of above a head and at feet of the authentication subject, after the authentication subject exits from the face authentication area on the entry restricted area side.

This disclosure is not limited to the example embodiments described above, but is allowed to be changed, if desired, without departing from the essence or spirit of this disclosure which can be read from the claims and the entire specification. An authentication system, an authentication method, and a recording medium with such changes are also intended to be within the technical scope of the present disclosure.

### DESCRIPTION OF REFERENCE CODES

1, 2, 3, 4, 5: Authentication system
11, 211: Image acquisition unit
12: Face authentication unit
13: Display unit
21: Arithmetic apparatus
22: Storage apparatus
23: Communication apparatus
24: Input apparatus
25: Output apparatus
26: Face feature quantity database
212: Tracking unit
213: Face authentication unit
214: Display control unit

What is claimed is:

1. An authentication system comprising:
at least one memory configured to store instructions;
at least one processor; and
a display unit,
wherein
the at least one processor is configured to execute the instructions to:
acquire an image including a face authentication area through which an authentication subject heading toward an entry restricted area passes, and
perform face authentication on the authentication subject, based on the acquired image, and
the display unit that is disposed at least one of above a head and at feet of the authentication subject, and that displays a result of the face authentication after the authentication subject exits from the face authentication area on the entry restricted area side.

2. The authentication system according to claim 1, wherein the result of the face authentication includes a first result indicating that the authentication subject is permitted to enter the entry restricted area, and a second result indicating that the authentication subject is not permitted to enter the entry restricted area.

3. The authentication system according to claim 1, wherein the display unit displays the result of the face authentication together with information indicating the authentication subject.

4. The authentication system according to claim 3, wherein the information indicating the authentication subject is a geometric pattern.

5. The authentication system according to claim 1, wherein the display unit displays the result of the face authentication, by changing a display color of a human figure corresponding to the authentication subject, based on the result of the face authentication.

6. The authentication system according to claim 1, wherein
the display unit includes a first display apparatus and a second display apparatus,
the first display apparatus and the second display apparatus are arranged side by side above the head of the authentication subject, and
an imaging unit that images the authentication subject is disposed between the first display apparatus and the second display apparatus.

7. The authentication system according to claim 1, wherein
the display unit includes a third display apparatus disposed at the feet of the authentication subject, and
the third display apparatus extends in a direction intersecting with a moving direction of the authentication subject.

8. The authentication system according to claim 7, wherein the third display apparatus is a LED tape.

9. The authentication system according to claim 7, wherein
the display unit includes a fourth display apparatus disposed at the feet of the authentication subject,
the third display apparatus extends in a direction intersecting with a moving direction of the authentication subject, and
the third display apparatus and the fourth display apparatus are arranged at intervals along the moving direction of the authentication subject.

10. The authentication system according to claim 1, wherein the display unit is disposed between the entry restricted area and the face authentication area.

11. The authentication system according to claim 1, wherein the display unit is disposed at a position corresponding to an edge on the side of the entry restricted area of the face authentication area.

12. The authentication system according to claim 1, wherein the face authentication area is disposed in front of the entry restricted area in a moving direction of the authentication subject heading toward the entry restricted area.

13. The authentication system according to claim 1, wherein
the display unit includes a first display apparatus disposed above the head of the authentication subject and a third display apparatus disposed at the feet of the authentication subject, and
the display unit changes order of displaying the result of the face authentication on the first display apparatus and the third display apparatus, based on the result of the face authentication.

14. An authentication method comprising:
acquiring an image including a face authentication area through which an authentication subject heading toward an entry restricted area passes;
performing face authentication on the authentication subject, based on the acquired image; and
displaying a result of the face authentication at least one of above a head and at feet of the authentication subject, after the authentication subject exits from the face authentication area on the entry restricted area side.

15. A non-transitory recording medium on which a computer program that allows a computer to execute an authentication method is recorded, the authentication method including:
acquiring an image including a face authentication area through which an authentication subject heading toward an entry restricted area passes;
performing face authentication on the authentication subject, based on the acquired image; and
displaying a result of the face authentication at least one of above a head and at feet of the authentication subject, after the authentication subject exits from the face authentication area on the entry restricted area side.

16. (canceled)
